(19) United States
(12) Patent Application Publication
(10) Pub. No.: US 2005/0076373 A1
(43) Pub. Date: Apr. 7, 2005

(54) Multi-displays supporting set-top box

(76) Inventor: Byung Dal Jung, Gyeonggi-do (KR)

Correspondence Address: BIRCH STEWART KOLASCH & BIRCH, PO BOX 747, FALLS CHURCH, VA, 22040-0747, US

(21) Appl. No.: 10/941,979

(22) Filed: Sep. 16, 2004

(30) Foreign Application Priority Data
Sep. 16, 2003 (KR) P2003-64032

(51) Int. Cl. H04N 7/173; H04N 7/18

(52) U.S. Cl. 725/80; 725/74; 725/131

(57) ABSTRACT

The present invention provides a multi-display supporting set-top box, by which home-networking TVs can be implemented by means of enabling digital broadcast viewing from a plurality of client display modules with one set-top box only. The present invention includes a receiving unit receiving a plurality of broadcast signals, a control unit receiving remote control signals from at least two client display modules, the control unit controlling the broadcast signals to be transferred to the client display modules as requested according the received remote control signals, respectively, and a distributing unit transferring the broadcast signals to a plurality of the client display modules according to control signals of the control unit, respectively.

This application claims the benefit of the Korean Application No. P2003-64032 filed on Sep. 16, 2003, which is hereby incorporated by reference.

### BACKGROUND OF THE INVENTION

1. Field of the Invention

The present invention relates to a set-top box, and more particularly, to a multi-display supporting set-top box enabling to support a plurality of client display modules simultaneously.

2. Discussion of the Related Art

Currently, many efforts are made to research and develop the digital TV and set-top box (STB) that can receive digital broadcast and data broadcast to prepare for full-scale digital broadcasting services.

As the analog TV has been spread worldwide, it is expected that a set-top box (hereinafter abbreviated STB) enabling the analog TV to receive the digital broadcast and data broadcast will be generalized prior to the generalization of the digital TV.

FIG. 1 is a block diagram for explaining the relations between TVs and STBs according to a related art.

Referring to FIG. 1, in order to enable a digital broadcast view, one STB 20 is assigned to drive one TV 10 in accordance with one-to-one correspondence.

Considering that one home possesses several TVs, a plurality of STBs 20 should be provided to the TVs, respectively to configure the one-to-one correspondence between the TVs 10 and the STBs 20. Hence, a user suffers from economical load in general.

Problems that may show up according to the relation between a digital TV and STB in the future are explained as follows.

First of all, a digital TV may replace STB. Namely, the digital TV is fully generalized so that the necessity of the currently used STB may vanish.

Yet, in such a case, the STB is still needed to drive a plurality of analog TVs at each home. Hence, a user should purchase STBs as many as the analog TVs so that a heavy burden may be financially imposed on the user.

Secondly, in case that the digital TV and STB coexist, it is expected that the digital broadcast is received by each home for the moment using one STB. A user then purchases digital TV later.

Besides, a system including a digital TV to which a relatively inexpensive STB is assembled can be developed for a user.

Thus, the future market may be developed into a trend that the digital TV and STB play roles as a display and a data broadcast receiver. And, it is presumed that the cable TV exclusive STB will be maintained as an independent terminal.

Namely, a system enabling one STB to drive a plurality of analog or digital TVs is competitive in price and performance to arouse customer's interest.

### SUMMARY OF THE INVENTION

Accordingly, the present invention is directed to a multi-display supporting set-top box that substantially obviates one or more problems due to limitations and disadvantages of the related art.

An object of the present invention is to provide a multi-display supporting set-top box, by which home-networking TVs can be implemented by means of enabling digital broadcast viewing from a plurality of client display modules with one set-top box only.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a multi-display supporting set-top box according to the present invention includes a receiving unit receiving a plurality of broadcast signals, a control unit receiving remote control signals from at least two client display modules, the control unit controlling the broadcast signals to be transferred to the client display modules as requested according the received remote control signals, respectively, and a distributing unit transferring the broadcast signals to a plurality of the client display modules according to control signals of the control unit, respectively.

Preferably, the multi-display supporting set-top box further includes a decoder decoding the received broadcast signals and a storage unit storing the decoded broadcast signals.

More preferably, each user's log or status file is stored in the storage unit.

Preferably, the multi-display supporting set-top box further includes an interface card responsible for an interface between the control unit and each of the client display modules.

More preferably, the interface card is selected from the group consisting of a LAN card, a wireless LAN card, and a HomePNA 2.0 card.

Preferably, the receiving unit includes a plurality of tuners sorting to receive the broadcast signals, respectively.

Preferably, the control unit identifies an ID from the received control signal received from each of the client display modules to transfer the corresponding broadcast signal to the corresponding client display module.

Preferably, the control unit is a micro controller unit (MCU).

In another aspect of the present invention, a multi-display supporting method includes the steps of receiving a plurality of broadcast signals in a receiving unit, decoding a plurality of the received broadcast signals, storing the decoded broadcast signals in a storage unit, receiving a control signal from each of the client display modules in a control unit, identifying an ID of the received control signal in the control unit, transferring the decoded broadcast signals to the client display modules, respectively, and displaying the transferred broadcast signals in the client display modules, respectively.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a block diagram for explaining the relations between TVs and STBs according to a related art;

FIG. 2 is a block diagram for explaining a relation between one STB and a plurality of TVs according to the present invention;

FIG. 3 is a block diagram of a server STB according to the present invention;

FIG. 4 is a block diagram of a server STB including a client device according to the present invention;

FIG. 5 is a block diagram of a digital TV home client system according to a first embodiment of the present invention;

FIG. 6 is a block diagram of a digital TV home client system according to a second embodiment of the present invention; and

FIG. 7 is a block diagram of a digital TV home client system according to a third embodiment of the present invention.

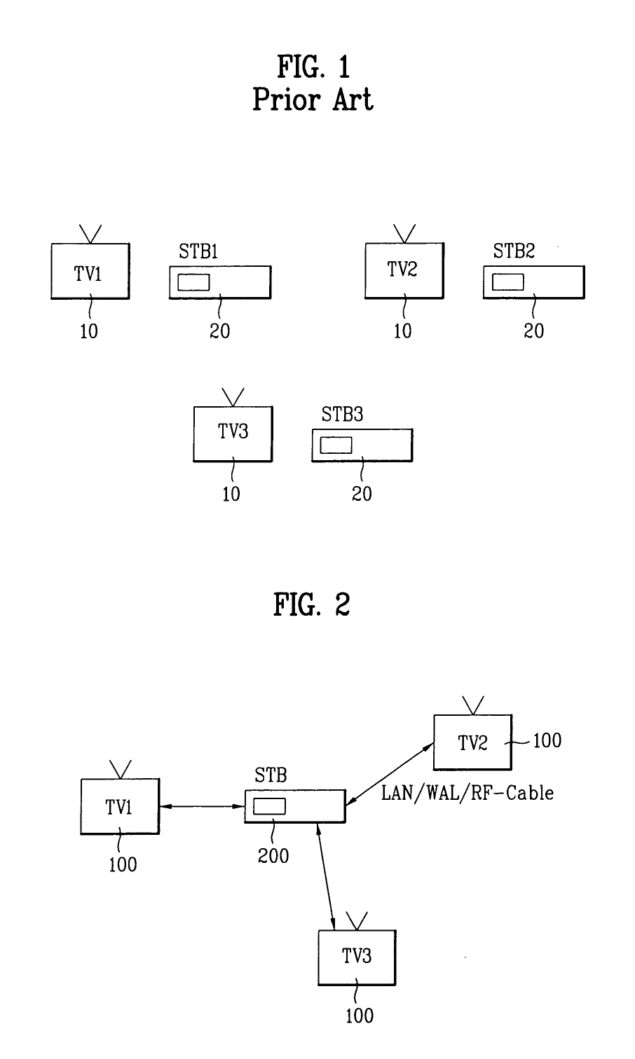

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

FIG. 2 is a block diagram for explaining a relation between one STB and a plurality of TVs according to the present invention.

Referring to FIG. 2, one server STB 200 drives three client display modules 100.

In doing so, each of the client display modules 100 is connected to the server STB 200 via LAN (local area network), WAN (wireless LAN), RF-cable, or the like.

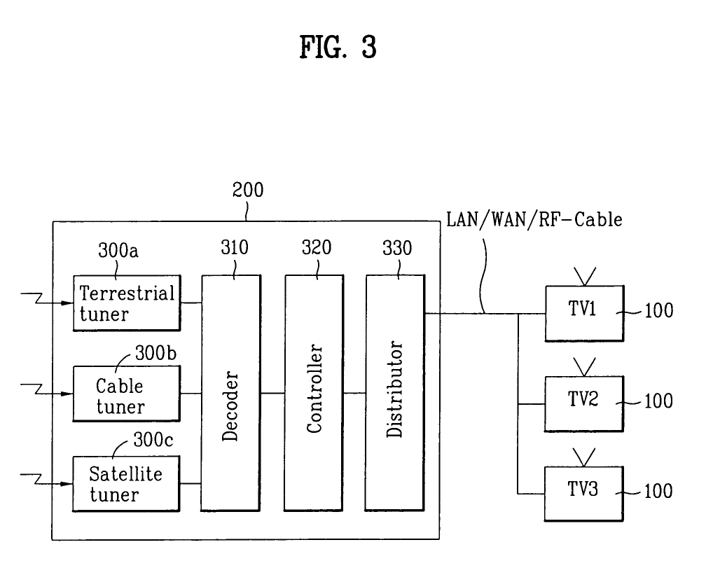

FIG. 3 is a block diagram of a server STB according to the present invention.

Referring to FIG. 3, the server STB 200 includes tuners 300a, 300b, and 300c for receiving air, cable, satellite, and Internet signals, respectively, a decoder 310 decoding the broadcast signals received via the tuners 300a, 300b, and 300c, a controller 320 receiving a remote control signal from each of the client display modules 100 and controlling the broadcast signals to be appropriately transferred per each of the client display modules 100 according to the received remote control signal, and a distributor 330 distributing the broadcast signals decoded by the decoder 310 to the client display modules 100, respectively according to a control signal of the controller 320.

The server STB 200 transmits/receives data to/from the client display module 100 via LAN/WAN card, HomePNA 2.0 card, or the like.

The server STB 200 receives the remote control signal from the client display module 100 and then provides a corresponding service.

In doing so, the corresponding service can be selected from the group consisting of a currently broadcast channel change/watch, a stored media watch, a PVR (personal video recorder) function, a still picture, an image zoom, Internet browser providing service, and the like.

For instance, explained in the following is a case that a terrestrial broadcast is received by the client display module TV1.

First of all, after a remote control (R/C) signal demanding for a terrestrial broadcast watch has been received from the TV1 via LAN/WAN card, HomePNA 2.0 card, or the like, the R/C signal is inputted to the controller 320 of the server STB 200.

In doing so, the controller 320 identifies ID of the corresponding client display module 100 from the inputted R/C signal.

And, the controller 320 controls an operation of the distributor 330 so that the broadcast signal, which was received via the tuner and decoded by the decoder 310, can be delivered to the TV1.

The distributor 330 transfers the corresponding broadcast signal to the TV1 via LAN, WAN, or RF cable according to the control of the controller 320 so that the terrestrial broadcast signal can be transferred to the TV1.

Thus, a user enables to watch the TV1 displaying the specific terrestrial broadcast.

Meanwhile, while the user is watching the TV1 displaying the specific terrestrial broadcast, the rest modules TV2 and TV3 can receive satellite broadcast, cable broadcast, terrestrial broadcast, and the like.

The channel, stored media, and the like watched by the users of the respective client display modules 100 can be known via Log or status files of the client display module users stored in the server STB 200, respectively.

The PVR (personal video recorder) function for the user of the client display module 100 is explained as follows.

First of all, once a user issues a command via a remote controller, the command is transferred to the server STB 200 via LAN, WAN, or RF-cable.

The controller of the server STB 200 then produces a control signal corresponding to the command so that the client display module performs the PVR function. Each detailed function of the PVR works in the same manner.

Meanwhile, in using Internet via the client display module 100, after data has been limitedly inputted to the client display module 100 via the remote controller or a screen keyboard or hardware such as a wireless keyboard, the inputted data is transferred to the server STB 200 via LAN, WAN, or RF-cable.

The server STB 200 is then linked to Internet via WAN port using an IP share function.

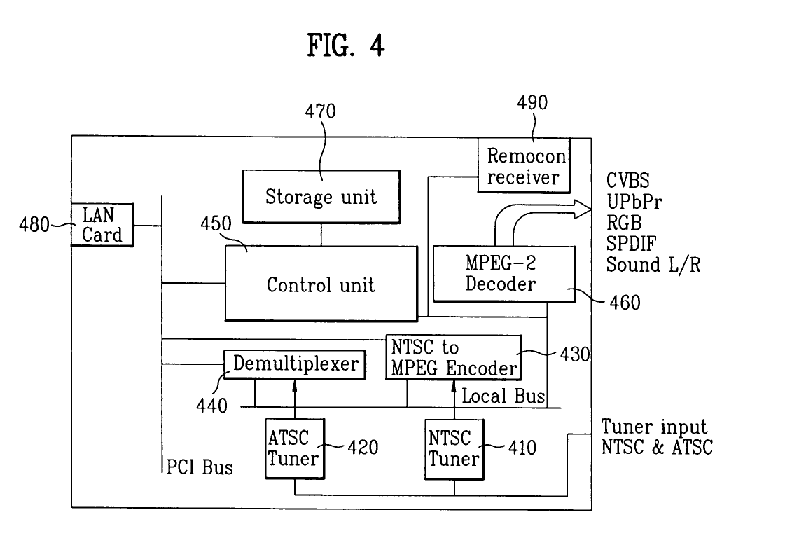

FIG. 4 is a block diagram of a server STB including a client device according to the present invention.

Referring to FIG. 4, the server STB 200 includes an NTSC tuner 410, an ATSC tuner 420, an MPEG-2 encoder 430, a demultiplexer 440, a controller 450, an MPEG-2 decoder 460, a storage unit 470, a LAN card 480, a remocon receiver 490 and the like.

First of all, an NTSC signal inputted to the NTSC tuner 410 is compressed into a data stream by the MPEG-2 encoder. The compressed data is transferred to the storage unit 470 connected to the controller 450 via local bus in a manner of DMA (direct memory access) transfer and is then stored in the storage unit 470.

Subsequently, the controller 450 receives R/C signals from the client display modules 100 to identify IDs of the client display modules, respectively. The controller 450 then controls broadcast signals to be appropriately transferred to the client display modules 100 according to the R/C signals, respectively.

In this case, the present invention uses a micro controller unit (MCU) as the controller 450.

Thereafter, the MPEG-2 decoder 460 decodes the data corresponding to each of the client display modules 100.

Accordingly, the client display modules 100 receive the decoded video/audio signals to display, respectively.

On the other hand, an ATSC signal inputted to the ATSC tuner 420 is converted to a transport stream (TS) by the demultiplexer 440 and the transport stream is then sent to the storage unit 470 connected to the controller 450.

Subsequently, the controller 450 receives R/C signals from the client display modules 100 to identify IDs of the client display modules, respectively. The controller 450 then controls broadcast signals to be appropriately transferred to the client display modules 100 according to the R/C signals, respectively.

Thereafter, the MPEG-2 decoder 460 decodes the data corresponding to each of the client display modules 100.

Accordingly, the client display modules 100 receive the decoded video/audio signals to display, respectively.

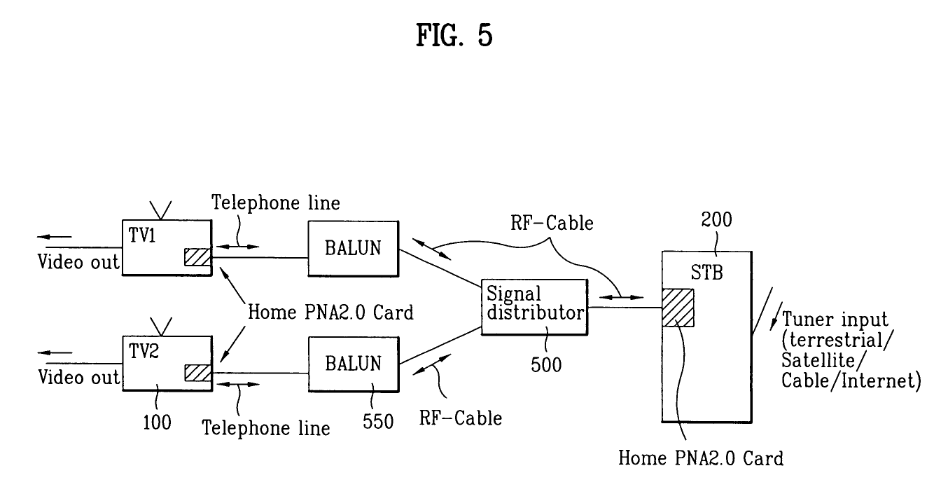

FIG. 5 is a block diagram of a digital TV home client system according to a first embodiment of the present invention.

Referring to FIG. 5, it is configured that HD signals of digital TV can be sufficiently transmitted/received between the server STB 200 and the client display modules 100 using HomePNA2.0 card.

In order to use an RF cable installed within a home, an impedance balance problem with a phone line is solved using a BALUN (balanced to unbalanced) 550.

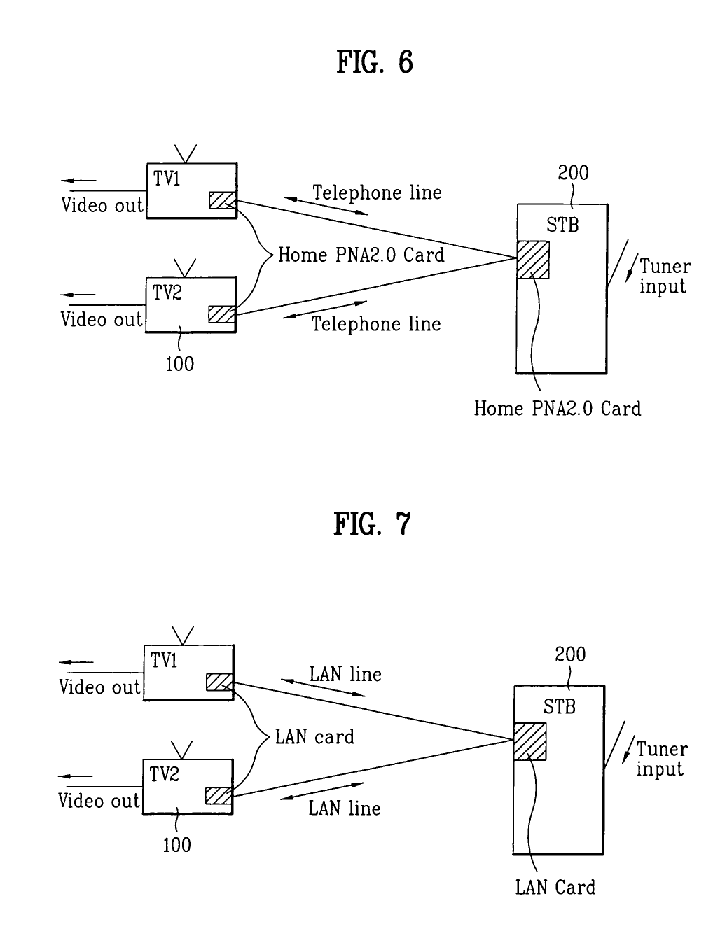

FIG. 6 is a block diagram of a digital TV home client system according to a second embodiment of the present invention.

Referring to FIG. 6, the HomePNA2.0 cards are used for the server STB 200 and the client display modules 100, respectively. And, the server STB 200 is connected to the client display modules 100 via previously installed phone lines.

FIG. 7 is a block diagram of a digital TV home client system according to a third embodiment of the present invention.

Referring to FIG. 7, the LAN cards are used for the server STB 200 and the client display modules 100, respectively. And, the server STB 200 is connected to the client display modules 100 via LAN lines. In such a case, a remote control is enabled via IP.

Since the line is not generally installed within home, the use of the LAN line will be preferable for the case that the server STB 200 located in a remote place such as an apartment management office drives a plurality of client display modules 100 located at a plurality of homes.

As mentioned in the foregoing description, a multi-display supporting set-top box according to the present invention enables one STB to supply various digital broadcasts to a plurality of client display modules.

Accordingly, compared to the related art method of providing a plurality of server STBS to a plurality of client display modules, respectively, the present invention enables to reduce a customers budget for the system.

It will be apparent to those skilled in the art that various modifications and variations can be made in the present invention. Thus, it is intended that the present invention covers the modifications and variations of this invention provided they come within the scope of the appended claims and their equivalents.

1. A multi-display supporting set-top box comprising:
a receiving unit receiving a plurality of broadcast signals;
a control unit receiving remote control signals from at least two client display modules, the control unit controlling the broadcast signals to be transferred to the client display modules as requested according to the received remote control signals, respectively; and
a distributing unit transferring the broadcast signals to a plurality of the client display modules according to control signals of the control unit, respectively.

2. The multi-display supporting set-top box of claim 1, further comprising:
a decoder decoding the received broadcast signals; and
a storage unit storing the decoded broadcast signals.

3. The multi-display supporting set-top box of claim 2, wherein each user's log or status file is stored in the storage unit.

4. The multi-display supporting set-top box of claim 1, further comprising an interface card responsible for an interface between the control unit and each of the client display modules.

5. The multi-display supporting set-top box of claim 4, wherein the interface card is selected from the group consisting of a LAN card, a wireless LAN card, and a HomePNA 2.0 card.

6. The multi-display supporting set-top box of claim 1, wherein the receiving unit comprises a plurality of tuners sorting to receive the broadcast signals, respectively.

7. The multi-display supporting set-top box of claim 1, wherein the control unit identifies an ID from the received control signal received from each of the client display modules to transfer the corresponding broadcast signal to the corresponding client display module.

8. The multi-display supporting set-top box of claim 1, wherein the control unit is a micro controller unit (MCU).

9. A multi-display supporting method comprising the steps of:
receiving a plurality of broadcast signals in a receiving unit;
decoding a plurality of the received broadcast signals;
storing the decoded broadcast signals in a storage unit;
receiving a remote control signal from each of the client display modules in a control unit;
identifying an ID of the received remote control signal in the control unit;
transferring the decoded broadcast signals to the client display modules, respectively; and
displaying the transferred broadcast signals in the client display modules, respectively.

10. The multi-display supporting method of claim 9, wherein each user's log or status file is stored in the storage unit.

11. The multi-display supporting method of claim 9, further comprising an interface card responsible for an interface between the control unit and each of the client display modules.

12. The multi-display supporting method of claim 11, wherein the interface card is selected from the group consisting of a LAN card, a wireless LAN card, and a HomePNA 2.0 card.

13. The multi-display supporting method of claim 9, wherein the receiving unit comprises a plurality of tuners sorting to receive the broadcast signals, respectively.

14. The multi-display supporting method of claim 9, the control unit is a micro controller unit (MCU).
